(19) United States
(12) Patent Application Publication
(10) Pub. No.: US 2001/0022549 A1
(43) Pub. Date: Sep. 20, 2001

(54) Motor vehicle door lock, motor vehicle door lock system and process for controlling a motor vehicle door lock

(76) Inventors: Ingo Mauel, Remscheid (DE); Rainer Josef Berger, Remscheid (DE)

Correspondence Address: NIXON PEABODY, LLP, 8180 GREENSBORO DRIVE, SUITE 800, MCLEAN, VA, 22102, US

(21) Appl. No.: 09/759,642

(22) Filed: Jan. 16, 2001

(30) Foreign Application Priority Data
Jan. 15, 2000 (DE) 100 01 415. 1

(51) Int. Cl. H04Q 1/00

(52) U.S. Cl. 340/5.72; 340/5.5; 340/5.21; 701/49

(57) ABSTRACT

An electrically controllable motor vehicle door lock, a motor vehicle door lock system with such a motor vehicle door lock, and a process for controlling the motor vehicle door lock. Simple and optimum adjustability of the functionality of the motor vehicle door lock is enabled by storing control parameters which determine the functionality of the motor vehicle door lock in an electrical storage. The control parameters are adaptable and can be changed so that the functionality of the motor vehicle door lock is fixed by its control parameters. Moreover, different control parameters or sets of control parameters can be used for different functioning states or closing states of the motor vehicle door lock, and therefore, the conditions for the passage from one state into another state of the motor vehicle door lock can be fixed regardless of which states or combination possibilities occur.

### BACKGROUND OF THE INVENTION

1. Field of the Invention

The invention relates to an electrically controlled motor vehicle door lock, an electrically controlled motor vehicle door lock system and a process for electrically controlling a motor vehicle door lock.

2. Description of the Related Art

A motor vehicle door lock preferably has high functionality, i.e., it can perform a host of different functions. As required, it is desirable to activate or deactivate some functions of the motor vehicle door lock. For example, a motor vehicle door lock for a rear motor vehicle door has a manually activated, mechanical switching means for activating or deactivating a child safety function, whereby the motor vehicle door lock is opened only by means of an outside activation lever.

U.S. Pat. No. 5,113,182 discloses a motor vehicle door lock system in which several motor vehicle door locks of a motor vehicle are connected to the motor vehicle electronics. The vehicle electronics has a central control module which controls the opening/closing and locking/unlocking of the motor vehicle door locks. This is accomplished by means of suitable software depending upon external control signals, such as actuating the outside actuating switch or a remote control. The functionality of the motor vehicle door lock system, therefore, whether opening a motor vehicle door unlocks all other motor vehicle door locks and can be preselected by manually actuated switches on the central control module.

The aforementioned motor vehicle door lock system with central activation or deactivation of the functions of the motor vehicle door locks does not match the high functionality of current motor vehicle door locks. Moreover, there is no required or different fixing of the functionality of individual motor vehicle door locks. Another disadvantage is that the central control module with its switches must be easily accessible in order to later be able to change the initial settings.

### SUMMARY OF THE INVENTION

An object of the present invention is to devise an electrically controllable motor vehicle door lock, a motor vehicle door lock system with at least one such motor vehicle door lock and a process for controlling one such motor vehicle door lock so that simple matching or fixing of the functionality of a motor vehicle door lock and the use of standardized motor vehicle door locks or software and/or hardware components for the motor vehicle door locks in various applications such as for a driver's door, a passenger's door, or a rear door are enabled. Generally, a motor vehicle door lock is defined here as a side door lock, a rear door lock, a rear hatch lock, a hood lock or the like for a motor vehicle.

Another object of the present invention is to individually use control parameters for each motor vehicle door lock, the control parameters being adaptable or can be changed as required, for example, to file them in a storage of the respective motor vehicle door lock or the like, so that the functionality of the motor vehicle door lock is fixed by its control parameters. In other words, electrical or electronic fixing of the functionality of the motor vehicle door lock occurs and proceeds decentralized in the respective motor vehicle door locks. This enables universal applicability of the motor vehicle door lock whereby the functionality of the door lock is set and changed by lock manufacturers and/or the motor vehicle manufacturer so that for various applications, the motor vehicle door lock or at least the same software or hardware components of the motor vehicle door lock can be used. This is advantageous since it results in financial savings with respect to manufacturing.

Another object of the present invention is that different control parameters or sets of control parameters can be used for different functioning states or closing states of the motor vehicle door lock. Therefore, the conditions for the passage from one state into another state of the motor vehicle door lock can be fixed regardless of which states or combination possibilities occur. Thus, an optimum configuration or adjustment possibility of the motor vehicle door lock easily arises.

Another object of the present invention is that the adjustment or fixing of the functionality of the motor vehicle door lock occurs simply by fixing or changing the control parameters in terms of software. This is advantageous with respect to a subsequent change or adaptation of the functionality of the motor vehicle door lock at the motor vehicle manufacturers or later in a motor vehicle workshop, since otherwise, a host of switches would have to be made accessible for each motor vehicle door lock and would have to be manually set. The adjustability of conditions for state transitions especially yields the advantage in that by combining the different parameters, new functions can be subsequently established which otherwise would have to be defined or fixed beforehand with major effort, for example, by providing a corresponding manually actuatable switch.

Other details, features, objectives and advantages of the present invention are detailed below using the drawings of one preferred embodiment.

### BRIEF DESCRIPTION OF THE PREFERRED EMBODIMENT

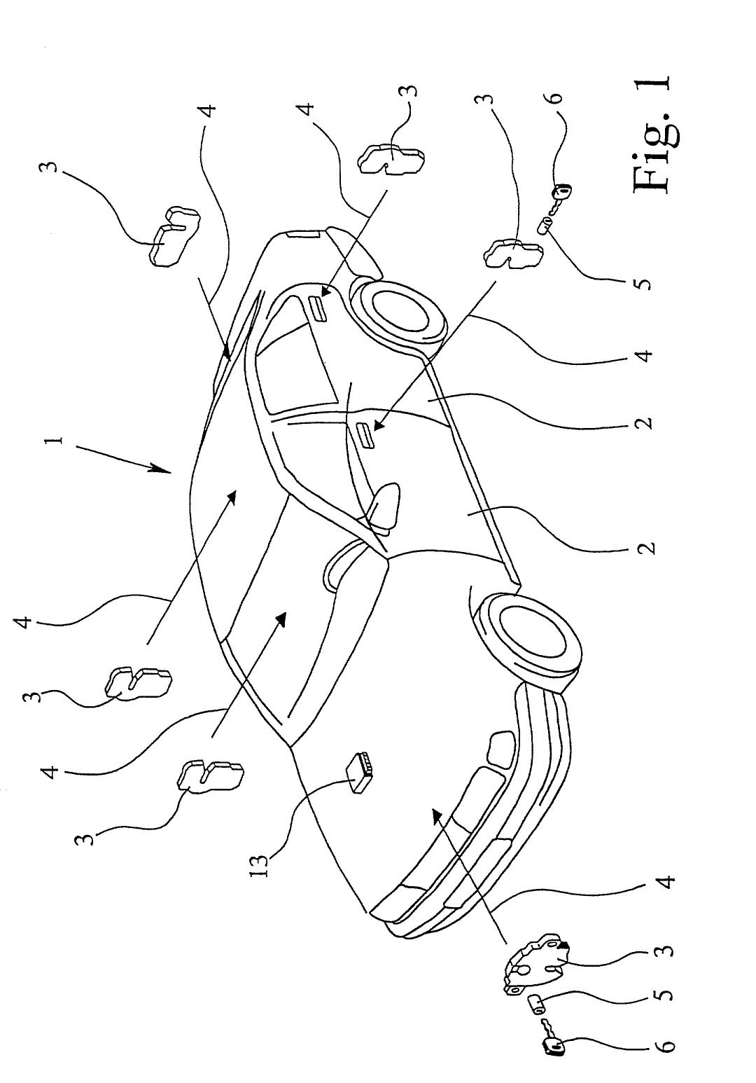

FIG. 1 shows a schematic perspective view of a motor vehicle with a motor vehicle door lock system which has several motor vehicle door locks;

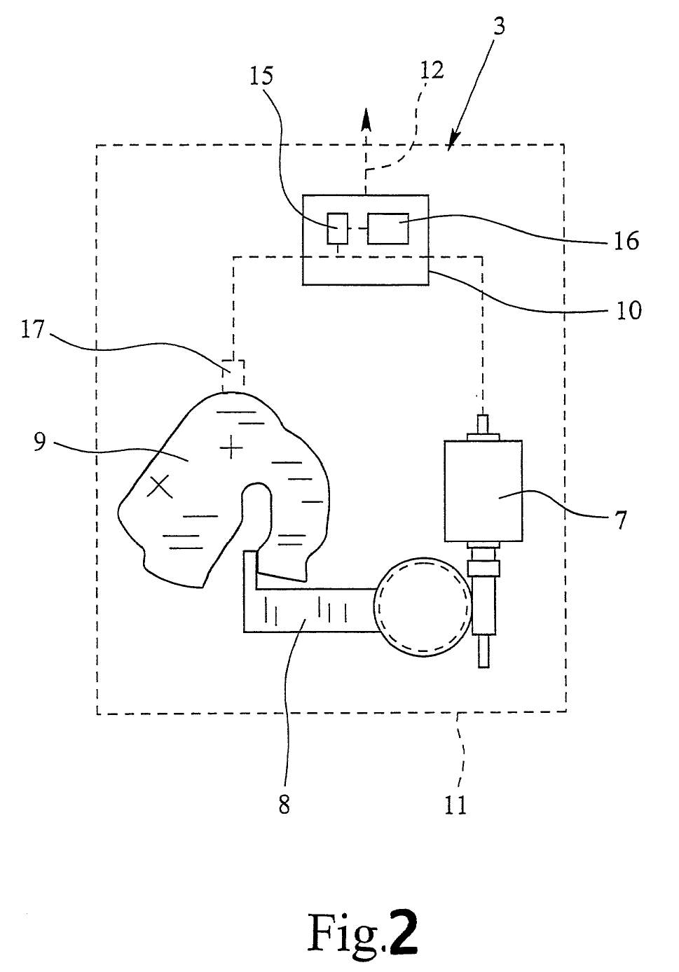

FIG. 2 shows a schematic of a motor vehicle door lock in accordance with the present invention; and

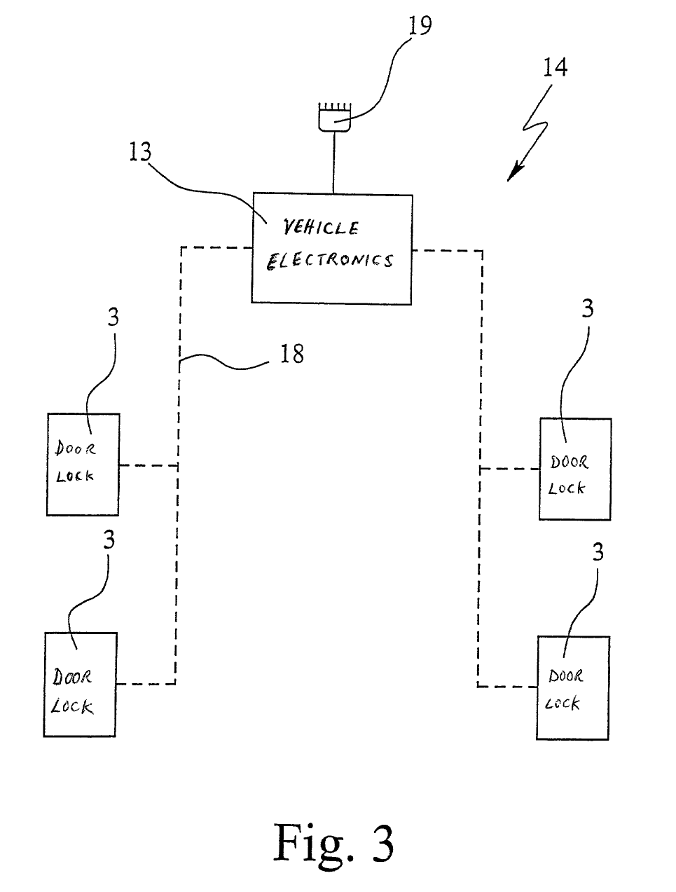

FIG. 3 shows a schematic of a motor vehicle door lock with four motor vehicle door locks.

### DETAILED DESCRIPTION OF THE PREFERRED EMBODIMENT

And now to the drawings, in which FIG. 1 shows a motor vehicle 1 with vehicle doors 2. Motor vehicle door locks 3 are assigned to at least the motor vehicle doors 2, the hood, the rear hatch and/or trunk of the motor vehicle 1, the arrows 4 indicating the approximate installation locations in FIG. 1. The motor vehicle door lock 3, at least in the instant that it is assigned to a motor vehicle door 2, is made as an electrically controllable lock, especially as an electric lock. In addition, a lock cylinder 5 can be conventionally assigned to the motor vehicle door lock 3, especially in the case of the driver's door, so that the motor vehicle door lock 3 can be locked and unlocked by means of a suitable key 6 or the like. The corresponding applies as required to the other motor vehicle door locks 3, and especially in the case of the hood lock and optionally also the rear lock there can be opening by means of a lock cylinder 5 and a suitable key 6. Generally, a motor vehicle door lock is defined here as a side door lock, a rear door lock, a rear hatch lock, a hood lock or the like for a motor vehicle.

FIG. 2 shows in a schematic the motor vehicle door lock 3 made as an electric lock. The motor vehicle door lock 3 has an electric motor drive 7 which acts on a conventional lock mechanism of the motor vehicle door lock 3, for example, on a detent pawl 8 which is used to secure an assigned rotary latch 9 of the motor vehicle door lock 3. The drive 7 is actuated by an electric motor, but can also be actuated by some other, especially electrically operating or controllable actuator or the like. In the execution of the drive 7, a control unit 10 is electrically connected to the drive 7. The control unit 10 is integrated into the motor vehicle door lock 3 and is installed especially in a housing 11 of the motor vehicle door lock 3 shown only by the broken line.

The motor vehicle door lock 3 also includes a terminal means 12, shown schematically in FIG. 2, such as a plug connector or the like (not shown), through which the motor vehicle door lock 3 or the control unit 10 is electrically connected to central electronics or the electronics 13 of the motor vehicle 1, as is shown in FIGS. 1 and 3. As shown in FIG. 3, the electronics 13 of the motor vehicle 1 and the motor vehicle door locks 3 connected thereto form a motor vehicle door lock system 14. As shown in FIG. 2, the control unit 10 preferably has a microprocessor 15 or the like for controlling or executing a corresponding control program. In addition, a storage 16 is integrated into the control unit 10 and is used to store control parameters which determine the functionality of the motor vehicle door lock 3 and in which the microprocessor 5 or the control program of the control unit 10 accesses. The control parameters are therefore stored in the motor vehicle door lock 3 or in the storage 16. The storage 16 is preferably electrically writable and electrically overwritable or erasable, and is preferably made as a so-called EEPROM. One such storage 16 is economically available and allows “electronic” setting or changing of the control parameters.

As shown in FIG. 2, the motor vehicle door lock 3 may also include a sensor 17 assigned to the rotary latch 9 for detecting at least one of the current lock position of the rotary latch 9 and the current position of the drive 7 and/or other lock parts. The sensor 17 is connected to the control unit 10 to make available sensor signals for controlling the motor vehicle lock 3 and/or for relaying signals which indicate the functioning or locking state to the vehicle electronics 13 such as a central interlock system or the like. As indicated in FIG. 3, the motor vehicle door locks 3 of the motor vehicle door lock system 14 are preferably connected via a bus system 18 to the central control or the electronics 13 of the motor vehicle 1. In particular, the bus system 18 can be a conventional CAN (Controlled Area Network) or the like. The terminal means 12 of the motor vehicle door locks 3 are accordingly connected thereto. Alternatively, the motor vehicle door locks 3 can also be connected in some other way, for example directly to the vehicle electronics 13.

Controls (not shown) assigned to the motor vehicle locks 3, such as an outside actuating switch or lever, an inside actuating switch or lever, a contact sensor, an actuation sensor and/or a central interlock switch, can be connected via the vehicle electronics 13, the bus system 18 and/or directly to the motor vehicle door locks 3. The controls, a remote control, the vehicle electronics 13 and/or other means deliver external control signals which are supplied accordingly to an assigned or connected motor vehicle door lock 3 or to several motor vehicle door locks 3. Thus, the control unit 10 of the respective motor vehicle door lock 3 controls the motor vehicle door lock 3 or the drive 7 with consideration of the control parameters filed in the storage 16, with the external control signals being modified or further processed in the respective motor vehicle door lock 3 or in the respective control unit 10.

When the control unit 10 of a motor vehicle door lock 3 receives an external control signal, for example, for opening the motor vehicle door lock 3 by an assigned inside actuation lever, the control or the control program initially checks whether the control parameter or parameters allow execution of the control signal, in this case, the opening of the motor vehicle door lock 3. This opening cannot be allowed when the inside actuation lever is actuated. The further processing or evaluation of the external control signals which proceeds preferably in the control unit 10 or the control program is detailed in the following. The storage 16 files a control parameter which activates or deactivates the child safety. With the child safety function deactivated, a corresponding bit in the storage 16 is set to “0”. With the child safety function off, the control bit is then set to “1”. The external control signal “opening based on actuating the inside locking lever”, considered a logic “1”, is subjected to logic operation with the control bit of the corresponding control parameter. This operation can be regarded as modification or filtering whereby a modified control signal arises. Depending upon the modified control signal, then the motor vehicle door lock 3 is either opened by means of the drive 7 (modified control signal=1) or not opened (modified control signal=0). An AND operation is recommended here. In the above explained operation and modification or filtration, the control parameter can also be regarded as a mask for modifying the corresponding external control signal.

It goes without saying that as a result of the different combination possibilities of the functioning states and locking states of the motor vehicle door lock 3 and the external control signals which can encounter one another, several control parameters can be linked to a control signal, optionally with other operations and/or with different weightings or priorities. Depending upon the combination and representation, multidimensional and/or several logic operations and/or vector-like or matrix-like operations or multiplication arise and are executed with consideration of the control parameters filed in the storage 16 by the control unit 10 and its microprocessors 15 by means of a corresponding control program or corresponding software. The control unit 10 also considers signals which were delivered by the sensor 17 and which communicate or image the locking state and/or functioning states, for example, the functioning state “unlocked”, from a central interlock means (not shown).

The door lock system of the present invention includes control parameters or sets of control parameters which are independent of one another for different states of the motor vehicle door lock 3 so that the control parameters fix or define only the conditions for transitions from one state of the motor vehicle door lock into another state of the motor vehicle door lock 3. A transition into another state takes place only when a corresponding external control signal is present or has been received, and the corresponding control parameter or parameters allow for this state change proceeding from the current state of the motor vehicle door lock 3 into the new state, and as a result forms a logic “1”. Thus, the greatest possible flexibility arises in the establishment of the functionality of the motor vehicle door lock 3.

Preferably, the input and/or change of the control parameters in the storage 16 of the motor vehicle door lock 3 takes place by means of corresponding software or by means of a corresponding program. In particular, it is provided that the control parameters are set or changed by means of the vehicle electronics 13 via the terminal means 12 and the bus system 18 or the like. Preferably, the control parameters can be fixed by means of the vehicle electronics 13. The motor vehicle lock system 14 may also include a setting device for inputting and/or changing the control parameters, and can be connected via a diagnostic connector 19 or other terminal means to the motor vehicle electronics 13, and thus, to the motor vehicle door lock 3.

While the present invention uses an electronic motor vehicle lock, it should appreciated by those skilled in the art that other types of lock mechanisms may also be used. Foe example, the motor vehicle door lock 3 need not necessarily be made as an electric lock. Rather, the motor drive 7 can act or can be actuated pneumatically or hydraulically. However, there must be an electrical control unit 10 which controls the drive 7.

We claim:

1. A motor vehicle door lock comprising:
an electric motor drive;
a control unit for controlling said electric motor drive; and
a terminal means for electrically connecting said control unit to electronics of the motor vehicle,
wherein said control unit has an assigned storage for storing at least one control parameter such that said at least one control parameter is read by said control unit to fix a functionality of said motor vehicle door lock, and
wherein said at least one control parameter is stipulated and changed by said terminal means.

2. The motor vehicle door lock as claimed in claim 1, wherein said at least one control parameter comprises at least one of different control parameters, independent control parameters, and sets of control parameters for at least one of different functioning states and locking states of said motor vehicle door lock.

3. The motor vehicle door lock as claimed in claim 2, wherein said at least one of different control parameters, independent control parameters, and sets of control parameters is dependent upon at least one of a current functioning state or a locking state of said motor vehicle lock.

4. The motor vehicle door lock as claimed in claim 1, wherein said storage is electrically writable and at least one of electrically overwritable and electrically erasable.

5. The motor vehicle door lock as claimed in claim 3, wherein said storage is electrically writable and at least one of electrically overwritable and electrically erasable.

6. The motor vehicle door lock as claimed in claim 1, wherein said terminal means electrically connects said control unit to the electronics of the motor vehicle via a bus system.

7. A motor vehicle door lock system comprising:
at least one motor vehicle door lock including an electric motor drive and a control unit for controlling said electric motor drive,
wherein said control unit electrically connects said at least one vehicle lock to electronics of the motor vehicle.

8. The motor vehicle door lock system as claimed in claim 7, further comprising a setting device for at least one of inputting and changing control parameters of said at least one motor vehicle door lock, wherein said setting device is electrically connected via a diagnostic connector to the electronics of the motor vehicle.

9. A process for controlling a motor vehicle door lock with an electric motor drive and a program-controlled control unit, said process comprising the steps of:
controlling said electric motor drive with said control unit depending upon external control signals from at least one of an outside actuation switch, a contact sensor, an actuation sensor, an inside actuation switch, a central interlock means and a remote control;
modifying said external control signals depending upon control parameters, said control parameters being dependent upon at least one of a respective functioning state and a locking state of said motor vehicle door lock; and
activating said electric motor drive depending upon the modified external control signals.

10. The process as claimed in claim 9, wherein said external control signals are logic states subject to a logic operation with a corresponding one of said control parameters.
